(19) United States
(12) Patent Application Publication
(10) Pub. No.: US 2017/0227222 A1
(43) Pub. Date: Aug. 10, 2017

(54) IMPINGEMENT COOLED WALL ARRANGEMENT

(71) Applicant: ANSALDO ENERGIA IP UK LIMITED, London (GB)

(72) Inventors: Felix Andreas BAUMGARTNER, Waldshut-Tiengen (DE); Michael Thomas MAURER, Bad Sackingen (DE); John Thomas HARRINGTON, Wettingen (CH)

(73) Assignee: ANSALDO ENERGIA IP UK LIMITED, London (GB)

(21) Appl. No.: 15/428,695

(22) Filed: Feb. 9, 2017

(30) Foreign Application Priority Data
Feb. 9, 2016 (EP) 16154862.3

(51) Int. Cl. F23R 3/06; F02C 7/18

(52) U.S. Cl. CPC F23R 3/06; F02C 7/18; F23R 2900/03044; F05D 2260/201

(57) ABSTRACT

An impingement cooled wall arrangement includes: an impingement sleeve and a wall exposed to a hot gas during operation, wherein the impingement sleeve is at least partly disposed in a plenum, and spaced at a distance from the wall to form a cooling flow path between the wall and the impingement sleeve such that compressed gas injected from the plenum through apertures in the cooling sleeve during operation impinges on the wall and flows as a cross flow towards an exit at a downstream end of the cooling flow path. Plural turbulators have a leading edge arranged on the wall. A center of at least one of the apertures is aligned along the longitudinal axis with the leading edge of at least one of a turbulators.

### PRIORITY CLAIM

This application claims priority from European patent application no. 16154862.3 filed on Feb. 9, 2016, the disclosure of which is incorporated by reference.

### TECHNICAL FIELD

The disclosure refers to an impingement cooling arrangement, more particularly to an impingement cooled wall arrangement for cooling a wall exposed to hot gases.

### BACKGROUND OF THE DISCLOSURE

The thermodynamic efficiency of power generating cycles depends on the maximum temperature of its working fluid, which in the case for example of a gas turbine is the hot gas exiting the combustor. The maximum feasible temperature of the hot gas is limited by combustion emissions as well as by the operating temperature limit of the metal parts in contact with this hot gas, and on the ability to cool these parts below the hot gas temperature. The cooling of the hot gas duct walls forming the hot gas flow paths of advanced heavy duty gas turbines is difficult and currently known cooling methods carry high performance penalties, i.e. lead to a reduction in power and efficiency.

Impingement cooling is one of the most effective cooling techniques for components which are exposed to gases with high hot gas temperatures. For impingement cooling of a wall a sleeve is disposed a short distance away from the wall outer surface (the surface facing away from the hot gas). The impingement sleeve contains an array of holes through which compressed gas discharges to generate an array of air jets which impinge on and cool the outer surface of the wall. After impingement the compressed gas flows as cooling gas in a cooling path delimited by the wall and the impingement sleeve towards an end of cooling flow path. This flow leads to a so called cross flow. Usually the first impingement rows allow impingement on the wall without any cross-flow in the cooling channel. As the number of subsequent impingement rows is increasing towards the end of the cooling flow path, the cross flow in the cooling channel builds up. As a disadvantage, the increasing cross flow in the cooling channel hinders and lowers the possible heat transfer coefficients of the impingement cooling as the impingement jets are diverted and bent away from the wall (see FIG. 2a) before they impinge on it.

To limit the cross flow velocity it has been suggested in the U.S. Pat. No. 4,719,748 to increase the height of the cooling channel over the length of the cooling channel. However, an increase of the height of the cooling channel reduces the impingement effect of the jet reaching the duct wall. Another solution in EP2955443 proposes adding additional impingement holes in combination with diverters.

In addition to the therefore decreasing efficiency of impingement cooling over the length of a wall cooled with impingement cooling the typical heat load of a duct wall is not homogeneous. For example, most combustion chambers of gas turbines show an inclination with respect to the engine axis, which leads to a change in the hot gas flow direction. The hot gas flow in the combustion chamber has to adapt to this change in main flow direction leading to areas with higher heat load, so-called hot spots, on typical locations off the combustion chamber walls. To ensure the life time of the areas of the wall which are exposed to increased heat load as increased cooling is required at these locations.

Taking in the consideration existing solution, there is a still need for efficient impingement cooling arrangements.

### SUMMARY OF THE DISCLOSURE

The main object of the present disclosure is to propose an impingement cooled wall arrangement which allows efficient impingement cooling of a wall independent of the position on the wall guiding a hot gas flow and to maintain a high cooling efficiency along the extension of a wall.

The disclosed impingement cooled wall arrangement comprises an impingement sleeve and a wall exposed to a hot gas during operation, wherein the impingement sleeve is at least partly disposed in a plenum, and spaced at a distance from the wall to form a cooling flow path between the wall and the impingement sleeve such that compressed gas injected from the plenum through the plurality of apertures in the cooling sleeve during operation impinges on the wall and flows as a cross flow towards an exit at a downstream end of the cooling flow path. The disclosed impingement cooled wall arrangement comprises also a plurality of turbulators having a leading edge arranged on the wall. The center of at least one of the apertures is aligned along the longitudinal axis with the leading edge of at least one of the turbulators.

According to one embodiment of the invention, the arrangement comprises at least one row of the apertures and at least one row of turbulators.

According to another embodiment of the invention, the number of the apertures is equal or smaller to the number of the turbulators.

According to yet another embodiment, each of the apertures is aligned with at least one of the turbulators.

According to another embodiment of the invention, all the turbulators have similar shape.

According to yet another embodiment, at least two of the turbulators are connected to each other.

According to another preferred embodiments, at least one of the turbulators has a V-shape, pyramid shape or shape of semi-circle.

According to yet another preferred embodiment, the turbulators are arranged downstream of the apertures in the direction of the cross flow.

Apart from impingement cooled wall arrangement, the disclosure describes also a combustor and gas turbine which comprises an impingement cooled wall arrangement according to one of the embodiments described above.

Further, a method for impingement cooling a wall exposed to a hot gas during operation is an object of the disclosure. The method comprises the steps of: injecting compressed gas from the plenum through apertures into the cooling flow path; impinging the compressed gas on the wall, and directing compressed gas as a cross flow towards an exit at a downstream end of the cooling flow path; and diverting the cross flow by the turbulators arranged on the wall.

### BRIEF DESCRIPTION OF THE DRAWINGS

The disclosure, its nature as well as its advantages, shall be described in more detail below with the aid of the accompanying drawings. Referring to the drawings:

FIG. 1 shows a gas turbine with a compressor, a combustion arrangement, and a turbine;

FIG. 2a, 2b shows an impingement cooled wall arrangement;

FIG. 3 shows schematically impingement flows in the wall arrangement;

FIG. 4 shows a top view of the impingement cooled wall arrangement with apertures and turbulators;

FIG. 5 shows schematically the impingement cooled wall arrangement with apertures and turbulators;

FIG. 6 shows the development of the resulting heat transfer coefficient over the length of a conventional impingement cooled wall and an impingement cooled wall with turbulators.

### EMBODIMENTS OF THE DISCLOSURE

The same or functionally identical elements are provided with the same designations below. The examples do not constitute any restriction of the disclosure to such arrangements.

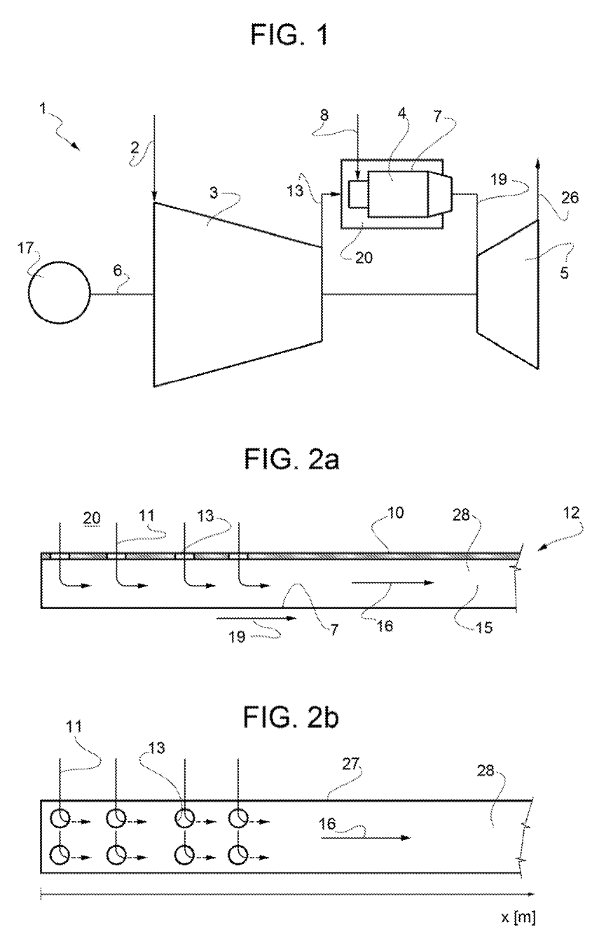

FIG. 1 shows a gas turbine 1 with an impingement cooled combustor 4. The gas turbine 1 comprises a compressor 3, a combustor 4, and a turbine 5. Intake air 2 is compressed to compressed gas 11 by the compressor 3 and feed to the combustor via a plenum 20 to the combustor 4. Fuel 8 is burned with the compressed gas in the combustor 4 to generate a hot gas flow 19. The hot gas is expended in the turbine 5 generating mechanical work. Typically, the gas turbine system includes a generator 17 which is coupled to a shaft 6 of the gas turbine 1. The gas turbine 1 further comprises a cooling system for the turbine 5 and the combustor 4, which is not shown, as it is not the subject of this disclosure. Exhaust gases 26 leave the turbine 5. The remaining heat is typically used in a subsequent water steam cycle, which is also not shown here.

FIG. 2a shows a cut through an impingement cooled wall arrangement 12 and FIG. 2b shows a top view of the impingement cooled wall arrangement 12 of FIG. 2a. As shown the impingement cooled wall arrangement 12 comprises a wall 7 which is exposed to a hot gas flow 19 on one side. A cooling sleeve 10 comprising apertures 14 for impingement cooling of the wall 7 is arranged at a distance above the wall 7. Compressed gas 11 is feed from the plenum 20 through apertures 13 and impinges on the wall 7. After the compressed gas 11 impinges on the wall 7 it flows as a cross flow 16 in the cooling flow path 15 formed by the wall 7 and the sleeve 10 towards the downstream end 28 of the cooling flow path 15. In the example of FIG. 2a the hot gas flow 19 and cross flow 16 flow in the same direction parallel to each other towards the downstream end 28 of the cooling flow path 15. FIG. 2b shows a top view of the arrangement of FIG. 2a. The impingement cooled wall arrangement 12 is delimited to an upstream end and to both sides by a cooling field wall 27. Two rows of apertures 13 are arranged in parallel. The compressed gas 11 flows through the apertures 13 to form a cross flow 16.

In the example shown in FIG. 2a, 2b apertures for compressed gas injection on the wall 7 are arranged in an upstream section of the impingement cooled wall arrangement 12. The downstream section is only cooled by the cross flow 16. The length x of the cooling flow path starting from the upstream end is indicated below the FIG. 2b.

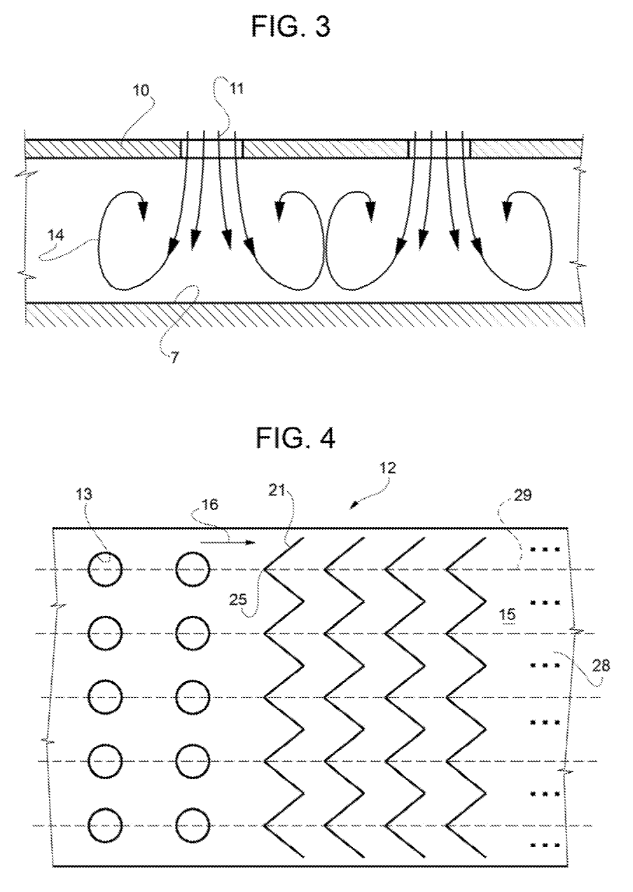

FIG. 3 shows impingement of the compressed gas flows 11 on the wall 7. After impingement, the secondary flows 14 are created.

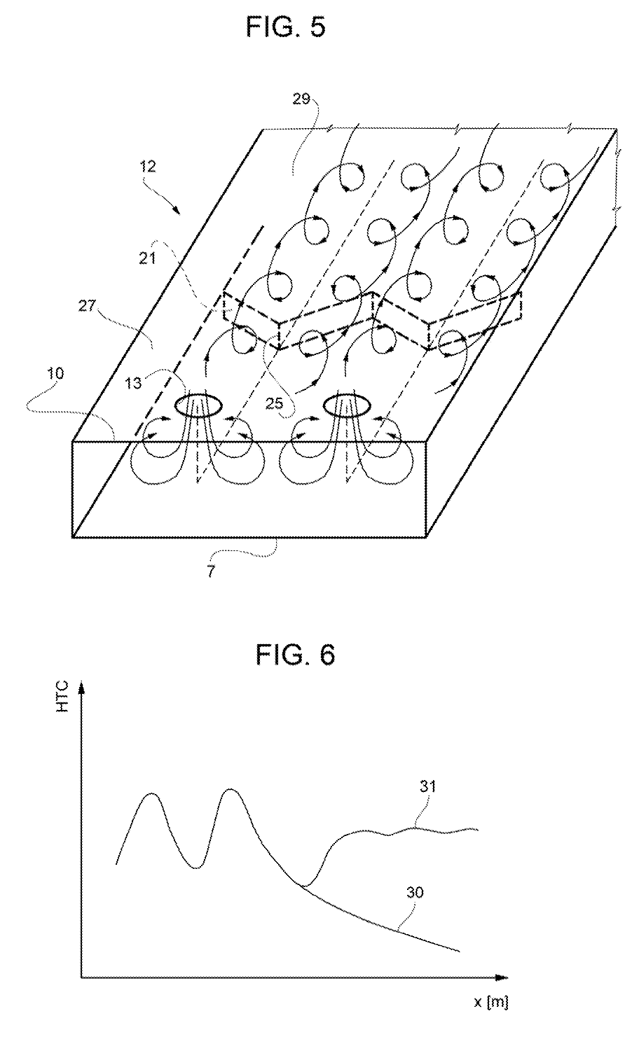

A first example of an impingement cooled wall arrangement 12 according to the disclosure is shown in FIG. 4 (which shows top view) and FIG. 5. The flow distribution immediately downstream of impingement apertures 13 is highly non-uniform with high momentum cores in alignment with the apertures 13. In FIG. 4, there are two rows of the apertures 13, and four rows of turbulators 21. The turbulators 21 have V-shape having a leading edge 25. The cross flow 16 is diverted by the turbulators 21, creating opposing vertices as shown in FIG. 5. According to the invention, the apertures 13 are aligned along the longitudinal axis 29 with the leading edge 25 of the turbulators 21. By aligning the turbulators 21 with the apertures 13, the design takes advantage of the high momentum cores produced by the apertures 13 in the downstream region, thereby increasing the heat transfer levels produced by these features. This design allows for more uniform heat transfer on the part, thereby increasing part life, as well as significantly reducing the required coolant mass flow by the removal of the downstream impingement apertures, reducing the amount of forfeited compressor work. FIG. 4 and FIG. 5 shows how the problem of reducing the mass flow and pressure drop requirements of the cooled part, while maintaining the high heat transfer produced by the upstream impingement rows, is solved eliminating the downstream rows from where the heat transfer is seen to decrease and instead place turbulators 21 aligned with the apertures 13. Alignment of the impingement apertures with the leading edges 25 is increasing the overall heat transfer level at the same pressure drop of the cooling system or vice versa. For non-casted parts there is a decrease in manufacturing costs due to a potential reduction of the number of turbulators.

The turbulators 21 can be connected to each other as shown in FIG. 4 and FIG. 5, or they may be separated (not shown). In addition, the turbulators 21 may have different shapes which can produce two opposing vertices. Such a shape includes pyramidal and semi-circle shapes.

FIG. 6 shows the illustration (not real data) of the development the resulting heat transfer coefficient (HTC) 30 over the length of the impingement cooled wall of FIG. 2a/2b and the heat transfer coefficient 31 of the impingement cooled wall with turbulators 21 of FIG. 4 and FIG. 5. The local peaks in cooling due to impingement of the compressed gas introduced through the apertures 13 on the wall 7 are clearly indicated. For the arrangement of FIG. 2a/2b without the turbulators 21 the peaks and overall heat transfer coefficient (HTC) is reduced along the length x of the cooling flow path 15. The resulting heat transfer coefficient over the length of the impingement cooled wall is an average heat transfer coefficient over the width of the cooled wall section. The peaks are reduced due to the cross flow 16 over the length x. For the arrangement with the turbulators 21 the heat transfer coefficient 31 is significantly improved.

The impingement cooled wall arrangement shown in embodiments can be used for example in a gas turbine with can combustors. The can combustors are typically circumferentially distributed around the shaft 6 of the gas turbine and have a transition piece or transition section for the transition from a circular cross section of the combustion chamber to a cross section with a shape of a section of an annulus or practically rectangular flow cross section at the outlet, i.e. at the turbine inlet. The transition piece can be integrated into the duct or be a separate duct and the disclosed impingement cooled wall arrangement can equally be used for the duct guiding the hot gases in the transition piece.

The disclosed impingement cooled wall arrangement and method for cooling can be used in gas turbines as well as in other machines or plants in which a wall is exposed to hot gas such as for example a furnace or a reactor.

It should be apparent that the foregoing relates only to the preferred embodiments of the present application and that numerous changes and modifications may be made herein by one of ordinary skill in the art without departing from the general spirit and scope of the invention as defined by the following claims.

### LIST OF DESIGNATIONS

1 Gas turbine
2 Intake air
3 Compressor
4 Combustor
5 Turbine
6 Shaft
7 Duct wall
8 Fuel
9 Burner
10 Sleeve
11 Compressed gas
12 Impingement cooled wall arrangement
13 Aperture
14 Secondary flow
15 Cooling flow path
16 Cross flow
17 Generator
19 Hot gas flow
20 Compressed gas plenum
21 Turbulator
25 Leading edge
26 Exhaust gas
27 Cooling field wall
28 Downstream end
29 Longitudinal axis
30 HTC without turbulators
31 HTC with turbulators

1. An impingement cooled wall arrangement, comprising:
an impingement sleeve; and
a wall configured for exposure to a hot gas during operation, wherein the impingement sleeve is at least partly disposed in a plenum, and spaced at a distance from the wall to form a cooling flow path between the wall and the impingement sleeve such that compressed gas injected from the plenum through a plurality of apertures in the cooling sleeve during operation will impinge on the wall and flow as a cross flow towards an exit at a downstream end of the cooling flow path; and
a plurality of turbulators having a leading edge arranged on the wall, wherein a center of at least one of the apertures is aligned along a longitudinal axis with the leading edge of at least one of the turbulators.

2. The impingement cooled wall arrangement according to claim 1, wherein the arrangement comprises;
at least one row of the apertures and at least one row of turbulators.

3. The impingement cooled wall arrangement according to claim 1, wherein a number of the apertures is equal or smaller than a number of the turbulators.

4. The Impingement cooled wall arrangement according to claim 1, wherein each of the apertures is aligned along the longitudinal axis with at least one of the turbulators.

5. The impingement cooled wall arrangement according to claim 1, wherein all the turbulators have similar shape.

6. The impingement cooled wall arrangement according to claim 1, wherein at least two of the turbulators are connected to each other.

7. The Impingement cooled wall arrangement according to claim 1, wherein at least one of the turbulators has a V-shape.

8. The impingement cooled wall arrangement according to claim 1, wherein at least one of the turbulators has a pyramid shape.

9. The impingement cooled wall arrangement according to claim 1, wherein at least one of the turbulators has a shape of a semi-circle.

10. The impingement cooled wall arrangement according to claim 1, wherein the turbulators are arranged downstream of the apertures in the direction of a cross flow.

11. A combustor comprising in combination:
a combustor outlet configured for a turbine; and
an impingement cooled wall arrangement according to claim 1.

12. A gas turbine comprising in combination;
a compressor;
a combustor connected with the compressor;
a turbine connected with the combustor, the combustor having an impingement cooled wall arrangement according to claim 1.

13. Method for impingement cooling a wall, inside a cooled wall arrangement having an impingement sleeve; and a wall configured for exposure to a hot gas during operation, wherein the impingement sleeve is at least partly disposed in a plenum, and spaced at a distance from the wall to form a cooling flow path between the wall and the impingement sleeve such that compressed gas infected from the plenum through a plurality of apertures in the cooling sleeve during operation will impinge on the wall and flow as a cross flow towards an exit at a downstream end of the cooling flow path; and a plurality of turbulators having a leading edge arranged on the wall, wherein a center of at least one of the apertures is aligned along a longitudinal axis with the leading edge of at least one of the turbulators, the coiled wall arrangement being exposed to a hot gas during operation, wherein an impingement sleeve is at least partly disposed in a plenum, and spaced at a distance from the wall to form a cooling flow path between the wall and the impingement sleeve, the method comprising:
injecting compressed gas from the plenum through apertures into the cooling flow path;
impinging the compressed gas on the wall;
directing compressed gas as a cross flow towards an exit at a downstream end of the cooling flow path; and
diverting the cross flow by the turbulators arranged on the wall.
